(19) United States
(12) Patent Application Publication
(10) Pub. No.: US 2026/0011127 A1
(43) Pub. Date: Jan. 8, 2026

(54) VALIDITY TESTING METHOD AND SYSTEM FOR DATA GENERATOR, AND ELECTRONIC DEVICE

(71) Applicant: NATIONAL INSTITUTE OF METROLOGY, CHINA, Beijing (CN)

(72) Inventors: Haiyong GAN, Beijing (CN); Wende LIU, Beijing (CN); Guojin FENG, Beijing (CN); Yingwei HE, Beijing (CN)

(21) Appl. No.: 18/880,258

(22) PCT Filed: Aug. 23, 2023
(86) PCT No.: PCT/CN2023/114386

§ 371 Date: Dec. 30, 2024

(30) Foreign Application Priority Data
Dec. 15, 2022 (CN) 202211636785.2

(51) Int. Cl. G06V 10/776; G06T 5/50; G06T 17/00; G06V 10/764

(52) U.S. Cl. CPC G06V 10/776; G06T 5/50; G06T 17/00; G06V 10/764; G06T 2207/20221

(57) ABSTRACT

A validity testing method and system for a data generator, and an electronic device. The method includes: obtaining a plurality of test targets and test backgrounds and a plurality of matching rules; obtaining physical fourth spatio-temporal feature data of a matching combination; forming a first mismatching combination and a second mismatching combination in both of which a background does not conform to the corresponding matching rule; respectively obtaining corresponding first spatio-temporal feature data and second spatio-temporal feature data; obtaining third spatio-temporal feature data by means of a data generator; comparing the third spatio-temporal feature data with the fourth spatio-temporal feature data, and obtaining a sub-score of the validity of the data generator; obtaining a plurality of sub-scores on the basis of the plurality of matching rules; and forming a total score of the validity of the data generator. The method assist evaluating data generator can for a desired data augmentation scenario.

### CROSS-REFERENCE TO RELATED APPLICATION

The present application claims priority to Chinese Patent Application No. 2022116367852, filed on Dec. 15, 2022, entitled “Validity Testing Method and System for Data Generator, and Electronic Device”, which is hereby incorporated by reference in its entirety.

### FIELD

The present application relates to the field of validity evaluation of virtual synthesis, and in particular to a test method and test system for validity of a data generator, and an electronic device.

### BACKGROUND

Generating new virtual data based on real data by means of virtual synthesis has a wide range of applications. For example, a new painting is virtually synthesized based on real painting images. For another example, a target image with a new background is virtually synthesized based on real target images.

For different demand scenarios, specific orientations of virtually synthesized tasks may be inconsistent, but they are all for meeting the pre-set requirements. In the present application, the degree of meeting the demands is referred as to validity. The virtually synthesized new data may be applied to specific tasks only when the validity reaches a certain level.

For the aforementioned means of virtual synthesis, how to evaluate the validity of its generated results is an issue that needs to be studied urgently.

The information disclosed in the background is only intended to deepen the understanding of the overall background technology of the present application, and should not be regarded as an acknowledgment or any form of implication that the information constitutes related art known to those skilled in the art.

### BRIEF SUMMARY

In view of the problems in the related art, the present application provides a test method and test system for validity of a data generator and an electronic device.

The present application provides a test method for validity of a data generator, where the data generator may synthesize virtual third space-time feature data based on physical first space-time feature data and physical second space-time feature data, where the first space-time feature data includes a first target and a first background, the second space-time feature data includes a second target and a second background, the third space-time feature data includes the first target and the second background, and the method includes:
obtaining a plurality of test targets, test backgrounds and a plurality of matching rules;
based on the matching rules, placing a test target in a test background matched with the test target to form a matching combination, and obtaining physical fourth space-time feature data about the matching combination;
based on the matching rules, replacing the test target and the test background with other test targets and other test backgrounds respectively, forming a first mismatching combination and a second mismatching combination, where a target in the first mismatching combination does not comply to the matching rules and a background in the second mismatching combination does not comply to the matching rules;
obtaining the corresponding first space-time feature data and the second space-time feature data respectively based on the first mismatching combination and the second mismatching combination;
obtaining the third space-time feature data based on the first space-time feature data and the second space-time feature data through the data generator;
comparing the third space-time feature data with the fourth space-time feature data to obtain a sub-score for the validity of the data generator;
obtaining a plurality of sub-scores based on the plurality of matching rules; and
forming a total score for the validity of the data generator based on the plurality of sub-scores.

According to the test method for the validity of a data generator provided by the present application, the target and/or the background is composed of a plurality of objects.

According to the test method for the validity of a data generator provided by the present application, the test background in the matching combination, the first mismatching combination, and the second mismatching combination includes the test targets in combinations in space-time coordinates.

According to the test method for the validity of a data generator provided by the present application, obtaining the plurality of sub-scores based on the plurality of matching rules includes:
for different matching rules, the obtained sub-scores are different when the corresponding third space-time feature data and the fourth space-time feature data have the same degree of similarity after comparison.

According to the test method for the validity of a data generator provided by the present application, the method further includes:
classifying the test targets and the test backgrounds, and assigning different scores based on different categories; and
obtaining the sub-scores for the validity of the data generator based on the scores assigned to the test background and the test target in the matching rules and a result of comparing the third space-time feature data and the fourth space-time feature data.

According to the test method for the validity of a data generator provided by the present application, for the matching rule, the more the features contained in the test background are the same as the features contained in the test target, the smaller the score corresponding to the matching rule, and vice versa, the fewer the features contained in the test background are the same as the features contained in the test target, the larger the score corresponding to the matching rule.

According to the test method for the validity of a data generator provided by the present application, forming the total score for the validity of the data generator based on the plurality of sub-scores includes:
for the test targets or the test backgrounds of different categories, obtaining a plurality of sub-scores in each category and forming a total score for the validity of the data generator in each category based on the plurality of sub-scores in each category; and/or,
for the test targets or the test backgrounds of different categories, obtaining a plurality of sub-scores in different categories and forming a total score for the validity of the data generator in each category based on the plurality of sub-scores in all categories.

The present application further provides a test system for validity of a data generator, where the data generator may synthesize virtual third space-time feature data based on physical first space-time feature data and second space-time feature data, where the first space-time feature data includes a first target and a first background, the second space-time feature data includes a second target and a second background, and the third space-time feature data includes the first target and the second background. The system includes:
an obtaining module, used for obtaining a plurality of test targets, test backgrounds and a plurality of matching rules;
a real data obtaining module, used for based on the matching rules, placing a test target in a test background matched with the test target to form a matching combination, and obtaining physical fourth space-time feature data about the matching combination;
a cross-combination module, used for based on the matching rules, replacing the test target and the test background with other test targets and other test backgrounds respectively, forming a first mismatching combination and a second mismatching combination, where a target in the first mismatching combination does not comply to the matching rules and a background in the second mismatching combination does not comply to the matching rules;
an input data obtaining module, used for obtaining the corresponding first space-time feature data and the second space-time feature data respectively based on the first mismatching combination and the second mismatching combination;
a data generation module, used for obtaining the third space-time feature data based on the first space-time feature data and the second space-time feature data through the data generator;
a comparison module, used for comparing the third space-time feature data with the fourth space-time feature data to obtain a sub-score for the validity of the data generator;
a loop module, used for obtaining a plurality of sub-scores based on the plurality of matching rules; and
a scoring module, used for forming a total score for the validity of the data generator based on the plurality of sub-scores.

The present application further provides an electronic device, including a memory, a processor, and a computer program stored on the memory and executable on the processor, where the processor, when executes the computer program, causes the processor to perform steps of the test method for the validity of the data generator described above.

The present application further provides a non-transitory computer-readable storage medium storing a computer program, where the computer program, when executed by a processor, causes the processor to perform steps of the test method for the validity of the data generator

In the test method and test system for validity of the data generator and the electronic device provided by the present application, a specific scoring and evaluation method for the validity of the data generator is provided, which assists in evaluating whether the data generator may be applied to a required data augmentation scenario. described above.

### BRIEF DESCRIPTION OF THE DRAWINGS

In order to illustrate the solutions in the embodiments of the present application or in the related art more clearly, the drawings used in the description of the embodiments or the related art are briefly described below. The drawings in the following description are only some embodiments of the present application, and other drawings may be obtained according to these drawings without any creative work for those skilled in the art.

FIG. 1 is a schematic flow chart of a test method for validity of a data generator according to the present application;

FIG. 2 is a schematic diagram of an input and an output of a data generator according to the present application;

FIG. 3 is a schematic structural diagram of a test system for validity of a data generator according to the present application; and

FIG. 4 is a schematic structural diagram of an electronic device according to an embodiment of the present application.

### DETAILED DESCRIPTION

To illustrate the objectives, solutions and advantages of the application, the solutions in the present application are described clearly and completely below in combination with the drawings in the application. The described embodiments are part of the embodiments of the application, not all of them. All other embodiments obtained by a person of ordinary skill in the art based on the embodiments of the present application without creative effort belong to the scope of the present application.

The test method for validity of the data generator according to the embodiment of the present application is described in detail in conjunction with the drawings through specific embodiments and their application backgrounds.

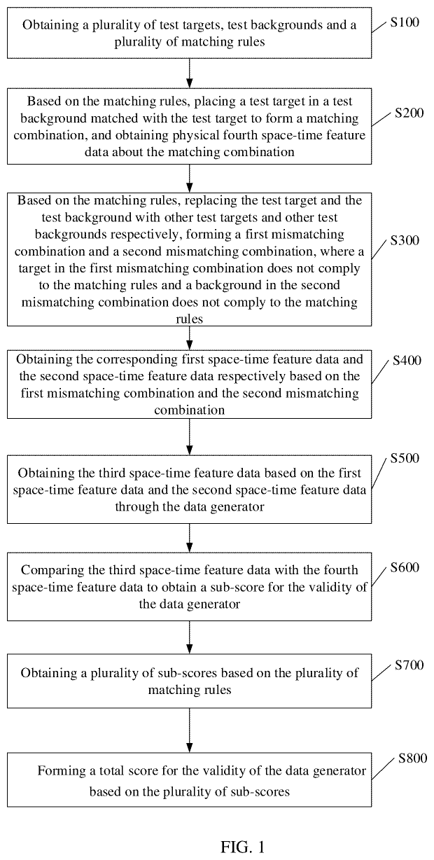

FIG. 1 is a schematic flow chart of a test method for validity of a data generator according to the present application. As shown in FIG. 1, the present application provides a test method for validity of a data generator, where the data generator may synthesize virtual third space-time feature data based on physical first space-time feature data and second space-time feature data, where the first space-time feature data includes a first target and a first background, the second space-time feature data includes a second target and a second background, and the third space-time feature data includes the first target and the second background. The method may include the following steps.

In an embodiment, the data generator is an image generator for synthesizing virtual images. For an image, the target may be a specific person or object in the image, and the background may be other people or objects other than the target.

In an embodiment, the data generator is an audio generator for synthesizing virtual audio. For audio, the target may be a main sound of the audio, and the background may be background noise.

S100: obtaining a plurality of test targets, test backgrounds and a plurality of matching rules.

In an embodiment, the target and/or background are composed of multiple objects.

The target and the background include both the aforementioned test target and test background, and the aforementioned first target, second target, first background and second background.

In an embodiment, the test background in the matching combination, the first unmatched combination and the second unmatched combination includes the test targets in combinations in a time-space coordinate.

In an embodiment, the combination of the target having certain characteristics in the time-space coordinates (SO, TO) and the background having certain characteristics in the time-space coordinates (SB, TB) may be formed that SB includes SO and TB includes TO. For example, in a time coordinate, a target of winter cannot be in the background of summer, and in a space coordinate, a target in the water cannot be in the background of a volcano.

S200: based on the matching rules, placing a test target in a test background matched with the test target to form a matching combination, and obtaining physical fourth space-time feature data about the matching combination.

In an embodiment, an association table storing matching rules is predetermined, and a test background matched with the test target is set in the association table.

In an embodiment, obtaining physical fourth space-time feature data about the matching combination refers to directly obtaining the space-time feature data of the matching combination, such as the image information, sound information, olfactory information, etc. of the matching combination based on physical sensors.

S300: based on the matching rules, replacing the test target and the test background with other test targets and other test backgrounds respectively, forming a first mismatching combination and a second mismatching combination, where a target in the first mismatching combination does not comply to the matching rules and a background in the second mismatching combination does not comply to the matching rules.

S400: obtaining the corresponding first space-time feature data and the second space-time feature data respectively based on the first mismatching combination and the second mismatching combination.

S500: obtaining the third space-time feature data based on the first space-time feature data and the second space-time feature data through the data generator.

In an embodiment, the first space-time feature data and the second space-time feature data are input into the data generator and the data generator outputs the third space-time feature data.

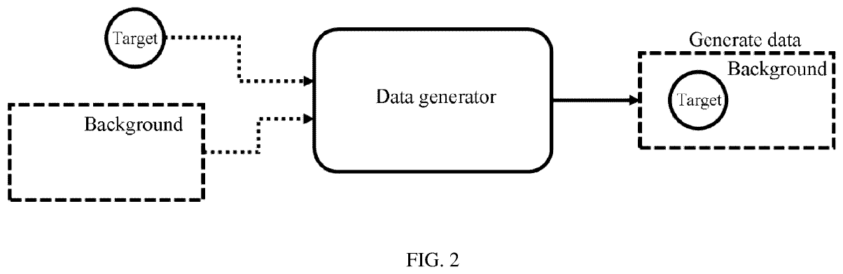

In an embodiment, the data generator has a capability to automatically separate the target from the background. FIG. 2 is a schematic diagram of an input and an output of a data generator according to the present application. As shown in FIG. 2, after the target and the background in both the first space-time feature data and the second space-time feature data are separated, the target and the background required by the matching rule are obtained respectively, and generated data that complies to the matching rule is synthesized.

In an embodiment, the data generator includes a neural network.

S600: comparing the third space-time feature data with the fourth space-time feature data to obtain a sub-score for the validity of the data generator.

S700: obtaining a plurality of sub-scores based on the plurality of matching rules.

To test the validity of the data generator, a plurality of matching rules are prepared in advance. In S700, all matching rules are traversed to obtain the sub-scores corresponding to all matching rules.

In an embodiment, obtaining the plurality of sub-scores based on the plurality of matching rules includes:
for different matching rules, the obtained sub-scores are different when the corresponding third space-time feature data and the fourth space-time feature data have the same degree of similarity after comparison.

In an embodiment, for different matching rules, difficulties in obtaining generated data with the same degree of authenticity are different. For virtual generation with greater difficulty, a higher sub-score is given to the virtual generation with greater difficulty compared with virtual generation with less difficulty when both have the same validity.

S800: forming a total score for the validity of the data generator based on the plurality of sub-scores.

In the test method for validity of the data generator provided by the present embodiments, a specific scoring and evaluation method for the validity of the data generator is provided, which assists in evaluating whether the data generator may be applied to a required data augmentation scenario.

In an embodiment, the method further includes:
classifying the test targets and the test backgrounds, and assigning different scores based on different categories; and
obtaining the sub-scores for the validity of the data generator based on the scores assigned to the test background and the test target in the matching rules and a result of comparing the third space-time feature data and the fourth space-time feature data.

In an embodiment, for a matching rule, the scores assigned to the test background and the test target may be combined to form the score of the matching rule; or the score of the matching rule may be formed only based on the test background or the test target.

In an embodiment, for the matching rule, the more the features contained in the test background are the same as the features contained in the test target, the smaller the score corresponding to the matching rule, and vice versa, the fewer the features contained in the test background are the same as the features contained in the test target, the larger the score corresponding to the matching rule.

In an embodiment, the target and the background usually may be combined together only when they have the same time or space features, and the higher the proportion of the same features, the lower the difficulty coefficient.

In an embodiment, forming the total score for the validity of the data generator based on the plurality of sub-scores includes:
for the test targets or the test backgrounds of different categories, obtaining a plurality of sub-scores in each category and forming a total score for the validity of the data generator in each category based on the plurality of sub-scores in each category; and/or,
for the test targets or the test backgrounds of different categories, obtaining a plurality of sub-scores in each category and forming a total score for the validity of the data generator in each category based on the plurality of sub-scores in all categories.

In an embodiment, a similarity between the generated data and the real data is determined firstly based on the matching rule, and the sub-score at the matching rule is then obtained based on the similarity and the difficulty of the preset matching rule. For the same category, a plurality of preset sub-scores are obtained based on a preset number of times, and the average of the plurality of preset sub-scores is obtained finally and taken as the total score of the category.

In an embodiment, for different categories, preset different numbers of samples are selected to obtain sub-scores, and all sub-scores are added as the total score for the test.

In an embodiment, for different categories, the same number of samples are selected to obtain sub-scores, a weight is set for each category, and all weighted sub-scores are added as the total score for the test.

In an embodiment, after the data generator determines that the validity has reached the standard, and a certain number of targets and backgrounds can be arranged and combined with the help of the data generator to obtain a large amount of generated data, which realizes data augmentation and applied to scenarios that require sample expansion, such as a scenario where a large amount of training data is required for neural network training, and another scenario where a large amount of samples to be identified are required to test the recognition capability of an intelligent recognition system.

A test system for validity of a data generator according to the present application is described below, and the test system for validity of a data generator described below and the test method for validity of a data generator described above may be referred to each other.

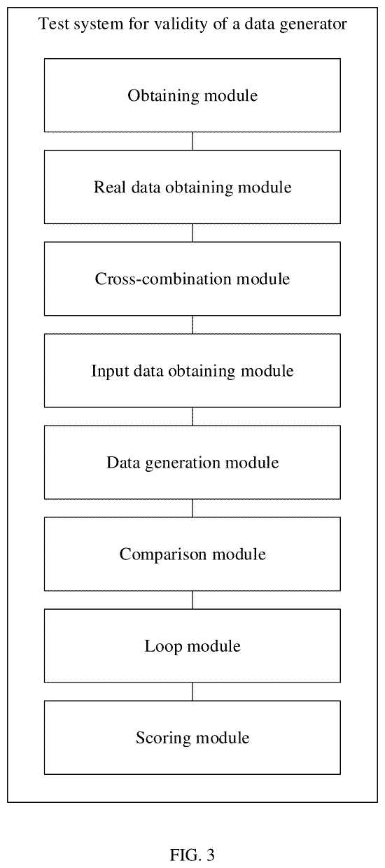

FIG. 3 is a schematic flow chart of a test system for validity of a data generator according to the present application. As shown in FIG. 3, the present application further provides a test system for validity of a data generator, where the data generator may synthesize virtual third space-time feature data based on physical first space-time feature data and second space-time feature data, where the first space-time feature data includes a first target and a first background, the second space-time feature data includes a second target and a second background, and the third space-time feature data includes the first target and the second background. The system may include:
an obtaining module, used for obtaining a plurality of test targets, test backgrounds and a plurality of matching rules;
a real data obtaining module, used for based on the matching rules, placing a test target in a test background matched with the test target to form a matching combination, and obtaining physical fourth space-time feature data about the matching combination;
a cross-combination module, used for based on the matching rules, replacing the test target and the test background with other test targets and other test backgrounds respectively, forming a first mismatching combination and a second mismatching combination, where a target in the first mismatching combination does not comply to the matching rules and a background in the second mismatching combination does not comply to the matching rules;
an input data obtaining module, used for obtaining the corresponding first space-time feature data and the second space-time feature data respectively based on the first mismatching combination and the second mismatching combination;
a data generation module, used for obtaining the third space-time feature data based on the first space-time feature data and the second space-time feature data through the data generator;
a comparison module, used for comparing the third space-time feature data with the fourth space-time feature data to obtain a sub-score for the validity of the data generator;
a loop module, used for obtaining a plurality of sub-scores based on the plurality of matching rules; and
a scoring module, used for forming a total score for the validity of the data generator based on the plurality of sub-scores.

In the test method for validity of the data generator provided by the present embodiments, a specific scoring and evaluation method for the validity of the data generator is provided, which assists in evaluating whether the data generator may be applied to a required data augmentation scenario.

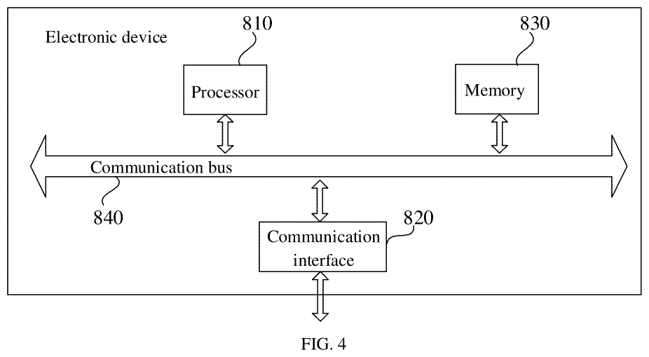

FIG. 4 is a schematic structural diagram of an electronic device according to the present application. As shown in FIG. 4, the electronic device may include a processor 810, a communication interface 820, a memory 830, and a communication bus 840. The processor 810, the communication interface 820, and the memory 830 communicate with each other through the communication bus 840. The processor 810 may call logic instructions in the memory 830 to perform a test method for validity of a data generator, where the data generator may synthesize virtual third space-time feature data based on physical first space-time feature data and second space-time feature data, where the first space-time feature data includes a first target and a first background, the second space-time feature data includes a second target and a second background, and the third space-time feature data includes the first target and the second background. The method includes:
obtaining a plurality of test targets, test backgrounds and a plurality of matching rules;
based on the matching rules, placing a test target in a test background matched with the test target to form a matching combination, and obtaining physical fourth space-time feature data about the matching combination;
based on the matching rules, replacing the test target and the test background with other test targets and other test backgrounds respectively, forming a first mismatching combination and a second mismatching combination, where a target in the first mismatching combination does not comply to the matching rules and a background in the second mismatching combination does not comply to the matching rules;
obtaining the corresponding first space-time feature data and the second space-time feature data respectively based on the first mismatching combination and the second mismatching combination;
obtaining the third space-time feature data based on the first space-time feature data and the second space-time feature data through the data generator;
comparing the third space-time feature data with the fourth space-time feature data to obtain a sub-score for the validity of the data generator;
obtaining a plurality of sub-scores based on the plurality of matching rules; and
forming a total score for the validity of the data generator based on the plurality of sub-scores.

In addition, the logic instructions in the memory 830 described above may be performed in the form of a software functional unit and may be stored in a computer readable storage medium while being sold or used as a separate product. Based on such understanding, the solution of the present application or a part of the solution, which is essential or contributes to the related art, may be embodied in the form of a software product, which is stored in a storage medium, including several instructions to cause a computer device (which may be a personal computer, server, or network device, etc.) to perform all or part of the steps of the methods described in various embodiments of the present application. The storage medium described above includes: a U disk, a mobile hard disk, a read-only memory (ROM), a random access memory (RAM), a magnetic disk, or an optical disk, and the like.

The present application further provides a computer program product, where the computer program product includes a computer program stored on a non-transitory computer-readable storage medium, the computer program includes a program instruction, when executed by a computer, the computer may perform a test method for the validity of the data generator provided above, where the data generator may synthesize virtual third space-time feature data based on physical first space-time feature data and second space-time feature data, where the first space-time feature data includes a first target and a first background, the second space-time feature data includes a second target and a second background, and the third space-time feature data includes the first target and the second background. The method includes:
obtaining a plurality of test targets, test backgrounds and a plurality of matching rules;
based on the matching rules, placing a test target in a test background matched with the test target to form a matching combination, and obtaining physical fourth space-time feature data about the matching combination;
based on the matching rules, replacing the test target and the test background with other test targets and other test backgrounds respectively, forming a first mismatching combination and a second mismatching combination, where a target in the first mismatching combination does not comply to the matching rules and a background in the second mismatching combination does not comply to the matching rules;
obtaining the corresponding first space-time feature data and the second space-time feature data respectively based on the first mismatching combination and the second mismatching combination;
obtaining the third space-time feature data based on the first space-time feature data and the second space-time feature data through the data generator;
comparing the third space-time feature data with the fourth space-time feature data to obtain a sub-score for the validity of the data generator;
obtaining a plurality of sub-scores based on the plurality of matching rules; and
forming a total score for the validity of the data generator based on the plurality of sub-scores.

The present application further provides a non-transitory computer-readable storage medium storing a computer program, where the computer program, when executed by a processor, performs a test method for the validity of the data generator provided above, where the data generator may synthesize virtual third space-time feature data based on physical first space-time feature data and second space-time feature data, the first space-time feature data includes a first target and a first background, the second space-time feature data includes a second target and a second background, and the third space-time feature data includes the first target and the second background. The method includes:
obtaining a plurality of test targets, test backgrounds and a plurality of matching rules;
based on the matching rules, placing a test target in a test background matched with the test target to form a matching combination, and obtaining physical fourth space-time feature data about the matching combination;
based on the matching rules, replacing the test target and the test background with other test targets and other test backgrounds respectively, forming a first mismatching combination and a second mismatching combination, where a target in the first mismatching combination does not comply to the matching rules and a background in the second mismatching combination does not comply to the matching rules;
obtaining the corresponding first space-time feature data and the second space-time feature data respectively based on the first mismatching combination and the second mismatching combination;
obtaining the third space-time feature data based on the first space-time feature data and the second space-time feature data through the data generator;
comparing the third space-time feature data with the fourth space-time feature data to obtain a sub-score for the validity of the data generator;
obtaining a plurality of sub-scores based on the plurality of matching rules; and
forming a total score for the validity of the data generator based on the plurality of sub-scores.

The device embodiments described above are merely illustrative, where the units described as separate components may or may not be physically separate, and the components displayed as units may or may not be physical units, that is, may be located at the same place or be distributed to multiple network units. Some or all of the modules may be selected according to actual needs to achieve the purpose of the solution of the present embodiment. Those skilled in the art may understand and implement the embodiments described above without paying creative labors.

Through the description of the embodiments above, those skilled in the art can clearly understand that the various embodiments can be implemented by means of software and a necessary general hardware platform, and of course, by hardware. Based on such understanding, the solution of the present application or a part of the solution, which is essential or contributes to the related art, may be embodied in the form of a software product, which is stored in a storage medium such as ROM/RAM, magnetic discs, optical discs, etc., including several instructions to cause a computer device (which may be a personal computer, server, or network device, etc.) to perform various embodiments or a part of the methods described in various embodiments.

It should be noted that the above embodiments are only used to explain the solutions of the present application, and are not limited thereto. Although the present application has been described in detail with reference to the foregoing embodiments, it should be understood by those skilled in the art that modifications to the solutions documented in the foregoing embodiments and equivalent substitutions to a part of the features may be made and these modifications and substitutions do not make the essence of the corresponding solutions depart from the scope of the solutions of various embodiments of the present application.

1. A test method for validity of a data generator, wherein the data generator synthesizes virtual third space-time feature data based on physical first space-time feature data and second space-time feature data, the first space-time feature data comprises a first target and a first background, the second space-time feature data comprises a second target and a second background, the third space-time feature data comprises the first target and the second background, the method comprising:
obtaining a plurality of test targets, test backgrounds, and a plurality of matching rules;
based on the plurality of matching rules, placing a test target in a test background matched with the test target to form a matching combination, and obtaining physical fourth space-time feature data about the matching combination;
based on the plurality of matching rules, replacing the test target and the test background with other test targets and other test backgrounds respectively, forming a first mismatching combination and a second mismatching combination, wherein a target in the first mismatching combination does not comply to the plurality of matching rules and a background in the second mismatching combination does not comply to the plurality of matching rules;
obtaining the corresponding first space-time feature data and the second space-time feature data respectively based on the first mismatching combination and the second mismatching combination;
obtaining third space-time feature data based on the first space-time feature data and the second space-time feature data through the data generator;
comparing the third space-time feature data with the fourth space-time feature data to obtain a sub-score for the validity of the data generator;
obtaining a plurality of sub-scores based on the plurality of matching rules; and
forming a total score for the validity of the data generator based on the plurality of sub-scores.

2. The test method of claim 1, wherein the target and/or the background is composed of a plurality of objects.

3. The test method of claim 1, wherein the test background in the matching combination, the first mismatching combination, and the second mismatching combination comprises the plurality of test targets in combinations in space-time coordinates.

4. The test method of claim 1, wherein obtaining the plurality of sub-scores based on the plurality of matching rules comprises:
for different matching rules of the plurality of matching rules, the plurality of sub-scores obtained are different when corresponding third space-time feature data and the fourth space-time feature data have the same degree of similarity after comparison.

5. The test method of claim 4, further comprising:
classifying the plurality of test targets and the test backgrounds, and assigning different scores based on different categories; and
obtaining the plurality of sub-scores for the validity of the data generator based on scores assigned to the test background and the test target in the plurality of matching rules and a result of comparing the third space-time feature data and the fourth space-time feature data.

6. The test method of claim 5, wherein, for a matching rule of the plurality of matching rules:
the more features contained in the test background that are the same as features contained in the test target there are, the smaller a score corresponding to the matching rule; and
the fewer the features contained in the test background that are the same as the features contained in the test target there are, the larger the score corresponding to the matching rule.

7. The test method of claim 5, wherein forming the total score for the validity of the data generator based on the plurality of sub-scores comprises:
for the plurality of test targets or the test backgrounds of the different categories, obtaining the plurality of sub-scores in each category of the different categories and forming the total score for the validity of the data generator in each category based on the plurality of sub-scores in each category; and/or
for the plurality of test targets or the test backgrounds of the different categories, obtaining the plurality of sub-scores in the different categories and forming the total score for the validity of the data generator in each category of the different categories based on the plurality of sub-scores in all categories of the different categories.

8. A test system for validity of a data generator, wherein the data generator synthesizes virtual third space-time feature data based on physical first space-time feature data and second space-time feature data, the first space-time feature data comprises a first target and a first background, the second space-time feature data comprises a second target and a second background, the third space-time feature data comprises the first target and the second background, and the system comprises:
an obtaining module, used for obtaining a plurality of test targets, test backgrounds and a plurality of matching rules;
a real data obtaining module, used for based on the plurality of matching rules, placing a test target in a test background matched with the test target to form a matching combination, and obtaining physical fourth space-time feature data about the matching combination;
a cross-combination module, used for based on the plurality of matching rules, replacing the test target and the test background with other test targets and other test backgrounds respectively, forming a first mismatching combination and a second mismatching combination, wherein a target in the first mismatching combination does not comply to the plurality of matching rules and a background in the second mismatching combination does not comply to the plurality of matching rules;
an input data obtaining module, used for obtaining corresponding first space-time feature data and the second space-time feature data respectively based on the first mismatching combination and the second mismatching combination;
a data generation module, used for obtaining the third space-time feature data based on the first space-time feature data and the second space-time feature data through the data generator;
a comparison module, used for comparing the third space-time feature data with the fourth space-time feature data to obtain a sub-score for the validity of the data generator;
a loop module, used for obtaining a plurality of sub-scores based on the plurality of matching rules; and
a scoring module, used for forming a total score for the validity of the data generator based on the plurality of sub-scores.

9. An electronic device comprising a memory, a processor, and a computer program stored in the memory and executable in the processor, wherein the processor, when executing the computer program, performs steps of the test method for validity of a data generator of claim 1.

10. A non-transitory computer-readable storage medium storing a computer program, wherein the computer program, when executed by a processor, performs steps of the test method for validity of a data generator of claim 1.
